(19) United States
(12) Patent Application Publication
(10) Pub. No.: US 2008/0154863 A1
(43) Pub. Date: Jun. 26, 2008

(54) Search engine interface

(76) Inventor: Renny Goldstein, Las Vegas, NV (US)

Correspondence Address: LITMAN LAW OFFICES, LTD., P.O. BOX 15035, CRYSTAL CITY STATION, ARLINGTON, VA, 22215, US

(21) Appl. No.: 11/987,993

(22) Filed: Dec. 6, 2007

Related U.S. Application Data
(60) Provisional application No. 60/873,593, filed on Dec. 8, 2006.

(51) Int. Cl. G06F 17/30

(52) U.S. Cl. 707/3; 707/E17.108

(57) ABSTRACT

The search engine interface is an input to a database search engine that presents to a user a graphical representation of the search criteria and the search results. The search criteria are displayed as tabs on a Web page presented by the user interface. Each tab has some indicia to associate the tab with its corresponding search criterion. Each search criterion presents one of a plurality of search terms operable by a predetermined Boolean relationship for input to the search engine. Each tab can be removed by the user to thereby remove the corresponding search term from the search engine. By adding or removing tabs, the user can navigate a search with a minimum number of keystrokes or other commands.

### CROSS-REFERENCE TO RELATED APPLICATION

This application claims the benefit of U.S. Provisional Patent Application Ser. No. 60/873,593, filed Dec. 8, 2006.

### BACKGROUND OF THE INVENTION

1. Field of the Invention

The present invention relates to search engine interfaces, and more particularly to a search engine interface that provides a graphical representation of active search criteria being used by a search engine.

2. Description of the Related Art

The Internet is burgeoning with adult XXX-rated entertainment Web sites featuring live entertainment sites and/or sites for downloading or ordering videos, DVDs and the like. Given the almost daily increase in published erotica content over the Internet, the choices presented to the adult content aficionado can be overwhelming. The adult content user may not know of a specific title. However he/she may desire a particular type of scene, body type, and the like. Therefore while perusing a porn site on the Web, it would be desirable for a user to be able to search for a particular fetish, scene, female or male type, action type, and the like. While many porn Web sites offer some rudimentary form of search capability, they do not offer a graphical means for display of search criteria that can be added or deleted merely by the click of the user's mouse.

Thus, a search engine interface solving the aforementioned problems is desired.

### SUMMARY OF THE INVENTION

The search engine interface is an input to a database search engine that presents to a user a graphical representation of the search criteria and the search results. The search criteria are displayed as tabs on a Web page presented by the user interface. Each tab has some indicia to associate the tab with its corresponding search criterion. Each search criterion presents one of a plurality of search terms operable by a predetermined Boolean relationship for input to the search engine. Each tab can be removed by the user to thereby remove the corresponding search term from the search engine. By adding or removing tabs, the user can navigate a search with a minimum number of keystrokes or other commands.

These and other features of the present invention will become readily apparent upon further review of the following specification and drawings.

### BRIEF DESCRIPTION OF THE DRAWINGS

FIG. 1 is a screen shot of a search engine interface according to the present invention.

FIG. 2 is a screen shot of a search engine interface according to the present invention, with a first selected search item.

FIG. 3 is a screen shot of a search engine interface according to the present invention with a second selected search item.

FIG. 4 is a screen shot of a search engine interface according to the present invention with a third selected search item.

FIG. 5 is a screen shot of a search engine interface according to the present invention with a user deselecting the third search item.

FIG. 6 is a screen shot of a search engine interface according to the present invention with a user deselecting the 2nd search item.

FIG. 7 is a screen shot of a search engine interface according to the present invention with a user deselecting the 1st search item.

Similar reference characters denote corresponding features consistently throughout the attached drawings.

### DETAILED DESCRIPTION OF THE PREFERRED EMBODIMENT

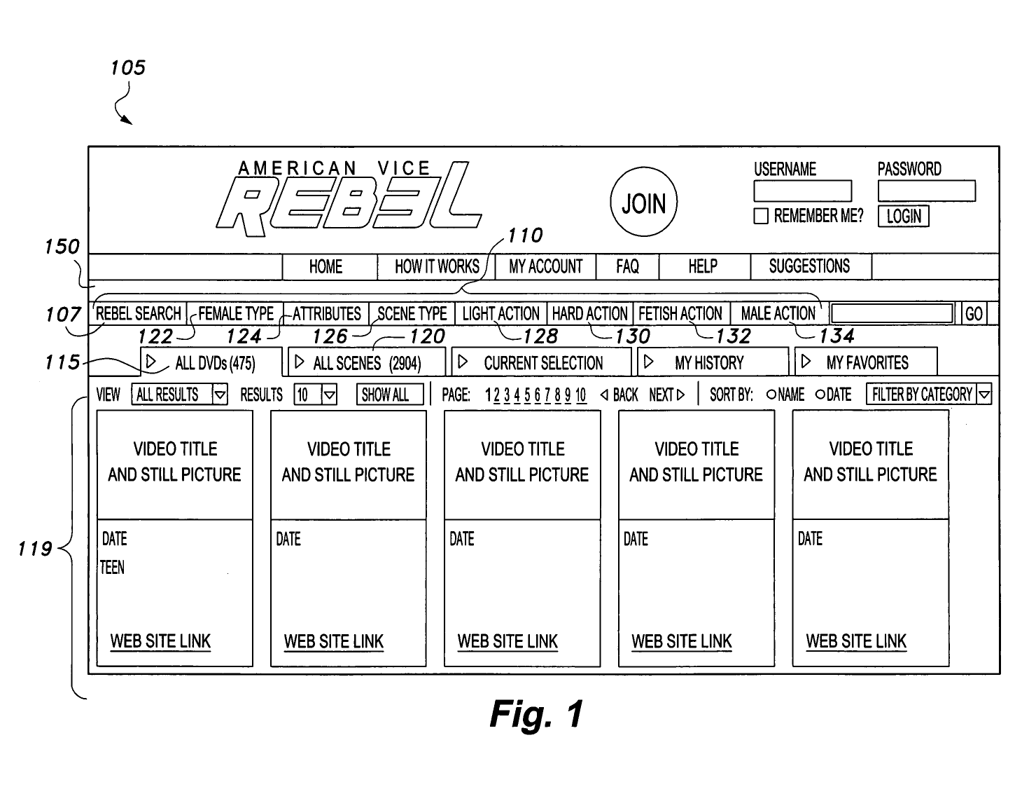

The present invention is a search engine interface, illustrated herein by screen shots 105 in FIGS. 1-7, that is operable on any Web browser, the search engine interface presenting to a user a graphical representation of search criteria and search results on one or more pages within a Web site. A search characteristics area may have an identifier 107 to guide a user to engage in “mouse over” (defined herein as a mouse movement over a defined area of the screen without clicking the mouse) corresponding to search characteristics, such as Female Type 122, Attributes 124, Scene Type 126, Light Action 128, Hard Action 130, Fetish Action 132, and Male Action 134.

The search results may comprise pictorial representations 119 of videos, DVDs, and the like that can be downloaded, rented, or purchased from the Website. The search results may also include one or more fields, such as an “All DVDs” field 115 and an “All scenes” field 120, the fields being populated with a respective number of hits fulfilling the search criteria.

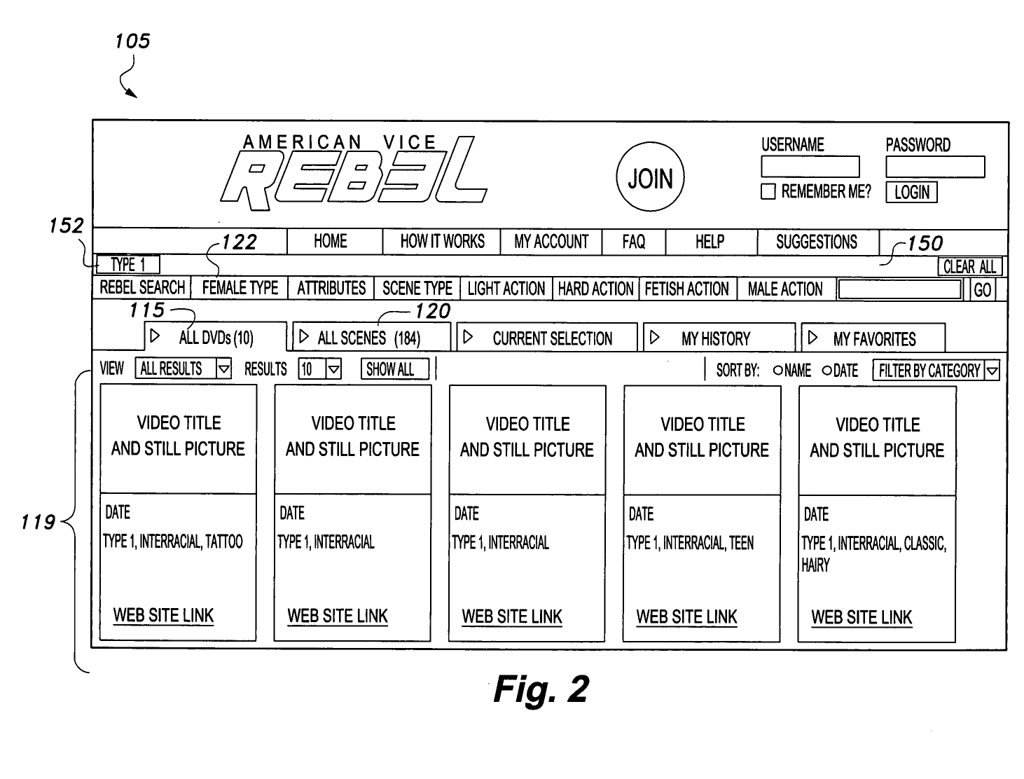

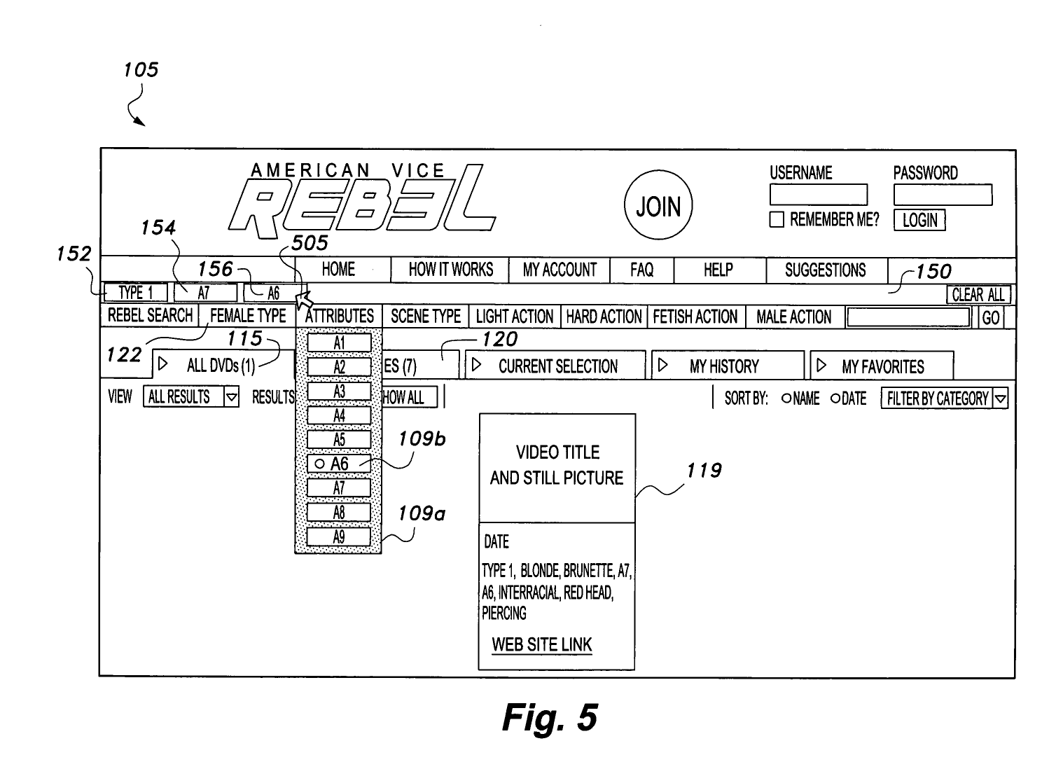

Mouse over search criteria menus 109a (shown in FIG. 5) may be provided under a plurality of main search bar categories 110 (shown in FIG. 1) so that the search criteria can be selected by the user as he/she mouses over the main categories 110. Additionally, the search criteria can be nested. When selected by the user, the search criteria are displayed as tabs, such as tab 152 (shown in FIG. 2), in a search item action bar 150 on the Web page presented by the user interface 105. Each selected search criterion 109b may be visibly highlighted in its respective search criteria menu 109a by reverse video or other well known techniques. Each tab on the search item action bar 150 has some indicia to associate the tab with its corresponding search criterion.

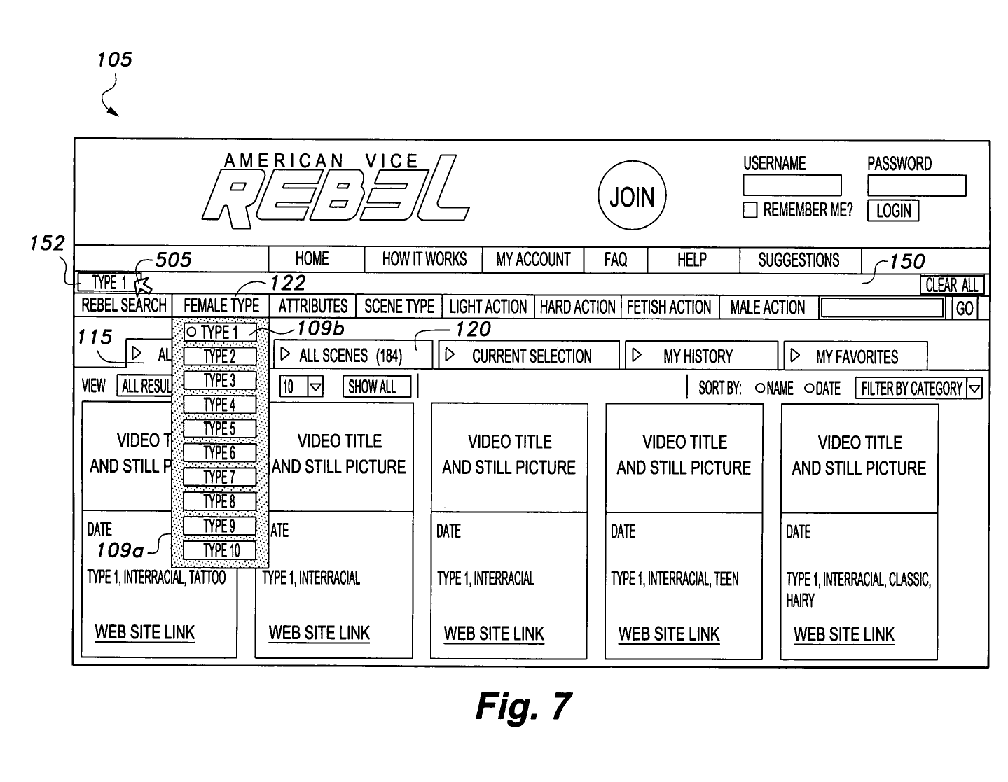

As shown in FIGS. 2-4, the tabs 152, 154, and 156 each have text corresponding to their respective search criterion. However, in the search engine interface of the present invention, the tab association indicia is not limited to text, i.e., the indicia may also be pictorial, symbolic, or the like. As shown in FIGS. 2 and 7, when a search criterion, such as the “Type1” criterion of “Female Type” category 122 has been selected, the corresponding tab 152 is displayed in the search item action bar 150, while becoming a highlighted member 109b of the associated search criteria menu 109a, as shown in FIG. 7. Note also that DVD hit list 115 and All Scenes hit list 120 change to reflect the applied search criterion 152.

Each search criterion selected from the search criteria menu 109a presents one of a plurality of terms operable by a predetermined Boolean relationship for input to the search engine. For example, the present invention can provide an AND function as a very straightforward, easy to use Boolean operation on the search criteria. As shown in FIGS. 2-4, tabs 152 154, and 156 are ANDed with each other to produce increasingly selective search results as tabs are sequentially added to the search item action bar 150.

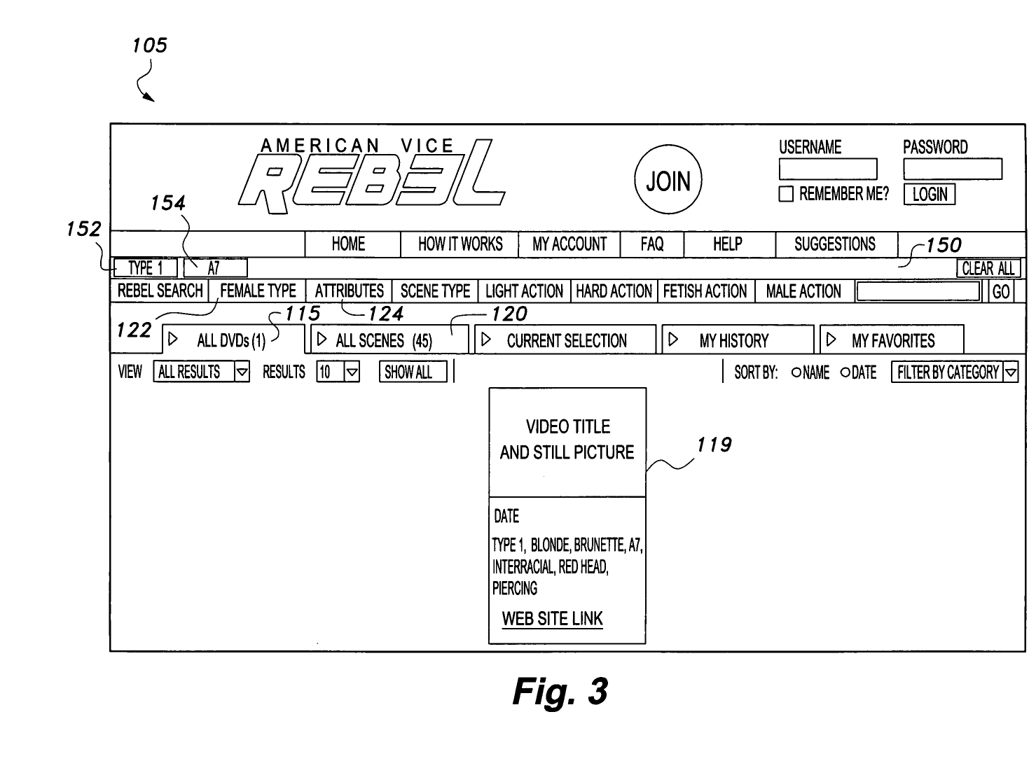

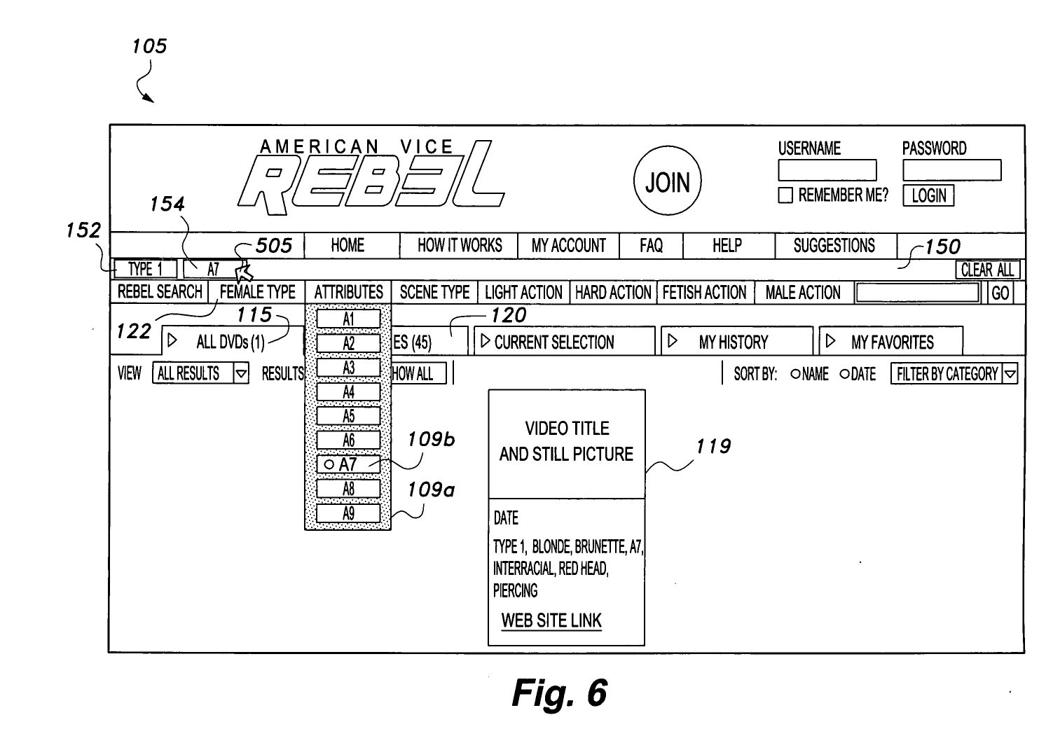

As shown in FIGS. 3 and 6, when a search criterion, such as “A7” of attributes category 124, has been selected, the corresponding tab 154 is displayed in the search item action bar 150, while becoming a highlighted member 109b of the associated search criteria menu 109a, as shown particularly in FIG. 6.

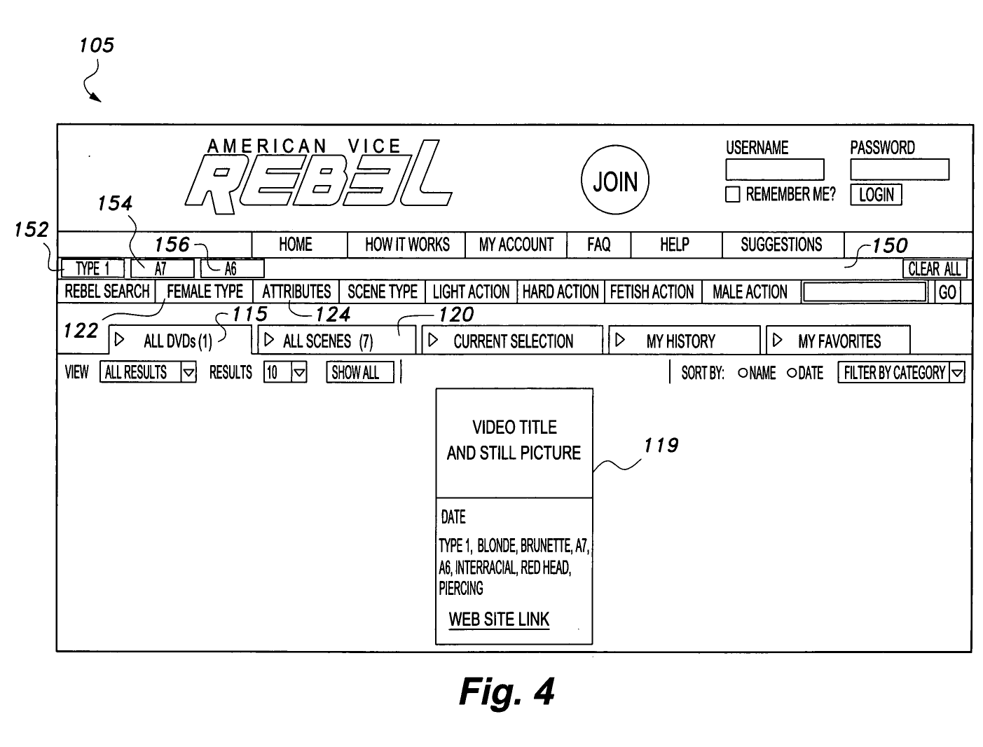

As shown in FIGS. 4 and 5, when a search criterion, such as “A6” of attributes category 124 has been selected, the corresponding tab 156 is displayed in the search item action bar 150, while becoming a highlighted member 109b of the associated search criteria menu 109a.

Additionally, it should be noted that the increasingly selective search criteria result progressively in fewer hits, as indicated in the hit lists 115 and 120. More complex Boolean relationships are also contemplated by the present invention.

As shown in FIGS. 5-7, each tab can be removed by the user to thereby remove the corresponding search term from the search engine. For example, as most clearly shown in FIG. 5, the user can place the mouse cursor 505 over the “A6” tab 156, and click on it to remove it from the search item action bar 150.

Similarly, as most clearly shown in FIG. 6, the user can place the mouse cursor 505 over the “A7” tab 154, and click on it to remove it from the search item action bar 150.

Additionally, as most clearly shown in FIG. 7, the user can place the mouse cursor 505 over the “Type1” tab 152, and click on it to remove it from the search item action bar 150.

It should be clearly understood that removal of a tab from the search item action bar 150 results in a corresponding removal of the related search criterion from input to the search engine, thus broadening the search, and resulting in a correspondingly increasing number of hits displayed in fields 115 and 120. By adding or removing tabs, the user can navigate a search with a minimum number of keystrokes or other commands.

The present invention may be implemented on any computing system and, preferably may be implemented in Macromedia Flash®, Java®, C, C++ and the like, on a Web server capable of serving Macromedia Flash®, Java®, C, C++ applets, and the like.

It is to be understood that the present invention is not limited to the embodiment described above, but encompasses any and all embodiments within the scope of the following claims.

I claim:

1. A user interface for a search engine, comprising:
a server computer having software operable thereon for publishing a web site on a computer network;
a search engine operably connected to the web site;
means for receiving search criteria at the web site for framing a search query to the search engine, the search criteria being entered by a client over the network;
means for displaying the search criteria as tabs on a web page published by the server computer, each of the tab having indicia to associate the tab with a corresponding search criterion, each of the search criteria being one of a plurality of search terms operable by a predetermined Boolean relationship for input to the search engine; and
means for displaying search results corresponding to the search terms, each of the tabs, responsive to the client's selection, being removable from the display to thereby remove the corresponding search term from the search query;
wherein the client can easily add or remove tabs in order to reframe the search query with a minimum number of actions.

2. The user interface for a search engine according to claim 1, wherein the user interface further comprises means for publishing a web page providing a search characteristics area on the client's screen, the search characteristics area having an identifier to guide the client to engage in mouse over movement over a defined area of the screen corresponding to defined search characteristics.

3. The user interface for a search engine according to claim 1, further comprising means for presenting the search results in a manner including pictorial representations of items for download, rental, or purchase from a web site.

4. The user interface for a search engine according to claim 1, further comprising means for presenting the search results in at least one field, the at least one field being populated with a respective number of hits fulfilling the search criteria.

5. The user interface for a search engine according to claim 1, further comprising means for nesting the search results.

6. The user interface for a search engine according to claim 1, further comprising means for displaying the tabs in a search item action bar area of the displayed page.

7. The user interface for a search engine according to claim 1, wherein the predetermined Boolean relationship for input to the search engine comprises an AND function.

8. The user interface for a search engine according to claim 1, further comprising means for presenting search terms as a plurality of user-selectable type categories.

9. The user interface for a search engine according to claim 8, further comprising means for presenting the search terms as a plurality of user-selectable attributes further defining the user selectable type categories.

10. A computer implemented method for a search engine user interface, comprising the steps of:
publishing a web site on a computer network, the web site having a search engine operably connected thereto;
publishing a web page on the web site permitting a client to enter search criteria for framing a query to the search engine;
displaying the search criteria as tabs on a web page published on the computer network;
displaying indicia on each of the tabs to associate each of the tab with a corresponding search criterion entered by the client;
presenting each of the search criterion as one of a plurality of search terms operable by a predetermined Boolean relationship for framing the query to the search engine;
displaying search results corresponding to the search terms; and
allowing a user to remove a tab from the display to thereby remove the corresponding search term from the query to the search engine;
wherein the user can easily add or remove tabs in order to reframe the search query with a minimum number of actions.

11. The computer implemented method for a search engine user interface according to claim 10, further comprising the step of publishing a web page providing a search characteristics area on the client's screen, the search characteristics area having an identifier to guide the user to engage in mouse over movement over a defined area of the screen corresponding to defined search characteristics.

12. The computer implemented method for a search engine user interface according to claim 10, wherein the search results comprise images of items available for download, rental, or purchase from a website.

13. The computer implemented method for a search engine user interface according to claim 10, wherein the search results include at least one field, the at least one field being populated with a respective number of hits fulfilling the search criteria.

14. The computer implemented method for a search engine user interface according to claim 10, further comprising the step of nesting the search results.

15. The computer implemented method for a search engine user interface according to claim 10, wherein the tabs are displayed in a search item action bar area of the displayed page.

16. The computer implemented method for a search engine user interface according to claim 10, wherein the predetermined Boolean relationship for input to the search engine comprises an AND function.

17. The computer implemented method for a search engine user interface according to claim 10, wherein the presented search terms comprise a plurality of user-selectable type categories.

18. The computer implemented method for a search engine user interface according to claim 17, wherein the presented search terms comprise a plurality of user-selectable attributes further defining the user-selectable type categories.
